(19) United States
(12) Patent Application Publication
(10) Pub. No.: US 2025/0368153 A1
(43) Pub. Date: Dec. 4, 2025

(54) INFORMATION PROCESSING DEVICE, INFORMATION PROCESSING METHOD, AND VEHICLE CONTROL SYSTEM

(71) Applicant: Sony Semiconductor Solutions Corporation, Kanagawa (JP)

(72) Inventor: Yosuke Kizu, Kanagawa (JP)

(21) Appl. No.: 18/874,287

(22) PCT Filed: Jun. 26, 2023
(86) PCT No.: PCT/JP2023/023659

§ 371 Date: Dec. 12, 2024

(30) Foreign Application Priority Data
Jul. 5, 2022 (JP) 2022-108121

(51) Int. Cl. B60R 16/037; B60W 10/30; B60W 40/08; B60W 60/00; G06T 7/73

(52) U.S. Cl. CPC B60R 16/037; G06T 7/73; B60W 10/30; B60W 40/08; B60W 60/00; B60W 2540/223; B60W 2710/30; G06T 2207/10048; G06T 2207/30201; G06T 2207/30268

(57) ABSTRACT

An information processing device according to the present disclosure includes a calculation unit and an estimation unit. The calculation unit calculates three-dimensional information of a driver on the basis of information from an imaging unit mounted on a vehicle. The estimation unit estimates an optimal driving posture of the driver on the basis of the three-dimensional information.

### FIELD

The present disclosure relates to an information processing device, an information processing method, and a vehicle control system.

### BACKGROUND

Recently, a technology of measuring a physical status of a driver by imaging a driver with an in-vehicle camera, and automatically adjusting a position of an in-vehicle device on the basis of a result of the measurement (see, for example, Patent Literature 1) has been disclosed.

### CITATION LIST

### Patent Literature

Patent Literature 1: Japanese Patent Application Laid-open No. 2019-55759

### SUMMARY

### Technical Problem

The present disclosure proposes an information processing device, an information processing method, and a vehicle control system that enable a driver to drive a vehicle in a more optimal posture.

### Solution to Problem

According to the present disclosure, there is provided an information processing device. The information processing device includes a calculation unit and an estimation unit. The calculation unit calculates three-dimensional information of a driver on the basis of information from an imaging unit mounted on a vehicle. The estimation unit estimates an optimal driving posture of the driver on the basis of the three-dimensional information.

### BRIEF DESCRIPTION OF DRAWINGS

FIG. 1 is a block diagram illustrating a configuration example of a vehicle control system according to an embodiment of the present disclosure.

FIG. 2 is a view illustrating an example of a sensing region according to the embodiment of the present disclosure.

FIG. 3 is a block diagram illustrating a detailed configuration example of the vehicle control system according to the embodiment of the present disclosure.

FIG. 4 is a view illustrating an example of an arrangement of an imaging unit according to the embodiment of the present disclosure.

FIG. 5 is a view illustrating an example of ideal posture information according to the embodiment of the present disclosure.

FIG. 6 is a view for describing an example of processing executed by the vehicle control system according to the embodiment of the present disclosure.

FIG. 7 is a view for describing an example of processing executed by the vehicle control system according to the embodiment of the present disclosure.

FIG. 8 is a view for describing an example of processing executed by the vehicle control system according to the embodiment of the present disclosure.

FIG. 9 is a flowchart illustrating an example of a procedure of control processing executed by the vehicle control system according to the embodiment of the present disclosure.

FIG. 10 is a flowchart illustrating an example of a procedure of adjustment processing executed by the vehicle control system according to the embodiment of the present disclosure.

FIG. 11 is a flowchart illustrating another example of the procedure of the adjustment processing executed by the vehicle control system according to the embodiment of the present disclosure.

### DESCRIPTION OF EMBODIMENTS

Hereinafter, embodiments of the present disclosure will be described with reference to the accompanying drawings. Note that the present disclosure is not limited to the following embodiments. In addition, the embodiments can be arbitrarily combined in a range in which the processing contents do not contradict each other. Also, in the following embodiments, the same reference sign is assigned to the same parts and an overlapped description thereof is omitted.

Recently, a technology of measuring a physical status of a driver by imaging a driver with an in-vehicle camera, and automatically adjusting a position of an in-vehicle device on the basis of a result of the measurement has been disclosed.

However, in the above-described conventional technology, since it has been difficult to accurately measure the physical status of the driver, there has been a case where the in-vehicle device such as a seat or a steering wheel cannot be adjusted to an optimal position. Thus, there has been a possibility that the driver cannot necessarily drive the vehicle in an optimal posture.

Thus, it is expected to realize a technology that overcomes the above-described problems and enables a driver to drive a vehicle in a more optimal posture.

### Configuration Example of a Vehicle Control System

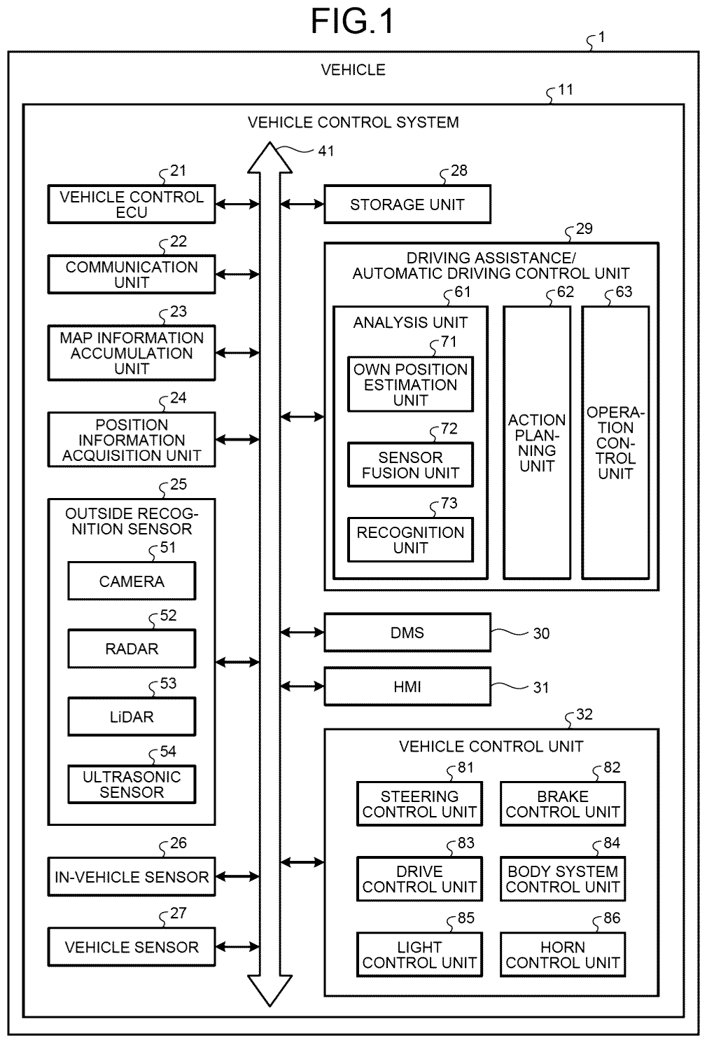

FIG. 1 is a block diagram illustrating a configuration example of a vehicle control system 11 that is an example of a mobile device control system to which the present technology is applied.

The vehicle control system 11 is provided in a vehicle 1 and performs processing related to driving assistance and automatic driving of the vehicle 1.

The vehicle control system 11 includes a vehicle control electronic control unit (ECU) 21, a communication unit 22, a map information accumulation unit 23, a position information acquisition unit 24, an outside recognition sensor 25, an in-vehicle sensor 26, a vehicle sensor 27, a storage unit 28, a driving assistance/automatic driving control unit 29, a driver monitoring system (DMS) 30, a human machine interface (HMI) 31, and a vehicle control unit 32. The vehicle control unit 32 is an example of an information processing device and a control unit.

The vehicle control ECU 21, the communication unit 22, the map information accumulation unit 23, the position information acquisition unit 24, the outside recognition sensor 25, the in-vehicle sensor 26, the vehicle sensor 27, the storage unit 28, the driving assistance/automatic driving control unit 29, the driver monitoring system (DMS) 30, the human machine interface (HMI) 31, and the vehicle control unit 32 are communicably connected to each other via a communication network 41. The communication network 41 includes, for example, an in-vehicle communication network, a bus, or the like conforming to a digital bidirectional communication standard such as a controller area network (CAN), a local interconnect network (LIN), a local area network (LAN), FlexRay (registered trademark), or Ethernet (registered trademark). The communication network 41 may be selectively used depending on a kind of data to be transmitted. For example, the CAN may be applied to data related to vehicle control, and the Ethernet may be applied to large-capacity data. Note that each unit of the vehicle control system 11 may be directly connected by utilization of wireless communication that assumes communication at a relatively short distance, such as near field communication (NFC) or Bluetooth (registered trademark) without the communication network 41.

Note that, hereinafter, in a case where each unit of the vehicle control system 11 performs communication via the communication network 41, description of the communication network 41 will be omitted. For example, in a case where the vehicle control ECU 21 and the communication unit 22 perform communication via the communication network 41, it is simply described that the vehicle control ECU 21 and the communication unit 22 perform communication.

The vehicle control ECU 21 includes, for example, various processors such as a central processing unit (CPU) and a micro processing unit (MPU). The vehicle control ECU 21 controls the entire or partial function of the vehicle control system 11.

The communication unit 22 communicates with various devices inside and outside the vehicle, other vehicles, servers, base stations, and the like, and transmits and receives various kinds of data. At this time, the communication unit 22 can perform communication by using a plurality of communication methods.

Communication with the outside of the vehicle which communication can be executed by the communication unit 22 will be schematically described. The communication unit 22 communicates with a server existing on an external network (hereinafter, referred to as an external server) or the like via a base station or an access point by a wireless communication method such as the fifth generation mobile communication system (5G), long term evolution (LTE), or dedicated short range communications (DSRC). The external network with which the communication unit 22 performs communication is, for example, the Internet, a cloud network, a company-specific network, or the like. The communication method performed by the communication unit 22 with respect to the external network is not specifically limited as long as being a wireless communication method capable of performing digital bidirectional communication at a predetermined communication speed or higher and at a predetermined distance or longer.

Furthermore, for example, the communication unit 22 can communicate with a terminal existing in the vicinity of the own vehicle by using a peer to peer (P2P) technology. The terminal existing in the vicinity of the own vehicle is, for example, a terminal worn by a moving body moving at a relatively low speed, such as a pedestrian or a bicycle, a terminal installed in a store or the like with a position being fixed, or a machine type communication (MTC) terminal. Furthermore, the communication unit 22 can also perform V2X communication. The V2X communication means, for example, communication between the own vehicle and another vehicle, such as vehicle to vehicle communication with another vehicle, vehicle to infrastructure communication with a roadside device or the like, vehicle to home communication, and vehicle to pedestrian communication with a terminal or the like possessed by a pedestrian.

For example, the communication unit 22 can receive a program for updating software that controls an operation of the vehicle control system 11 from the outside (Over The Air). The communication unit 22 can further receive map information, traffic information, information around the vehicle 1, and the like from the outside. Furthermore, for example, the communication unit 22 can transmit information related to the vehicle 1, information around the vehicle 1, and the like to the outside. Examples of the information related to the vehicle 1 and transmitted to the outside by the communication unit 22 include data indicating a state of the vehicle 1, a recognition result by a recognition unit 73, and the like. Furthermore, for example, the communication unit 22 performs communication corresponding to a vehicle emergency call system such as an eCall.

For example, the communication unit 22 receives an electromagnetic wave transmitted by Vehicle Information and Communication System (VICS) (registered trademark)), such as a radio beacon, an optical beacon, or FM multiplex broadcasting.

Communication with the inside of the vehicle which communication can be executed by the communication unit 22 will be schematically described. The communication unit 22 can communicate with each device in the vehicle by using, for example, wireless communication. The communication unit 22 can perform wireless communication with an in-vehicle device by a communication method capable of performing digital bidirectional communication at a predetermined communication speed or higher by wireless communication, such as a wireless LAN, Bluetooth, NFC, or wireless USB (WUSB). The communication unit 22 is not limited to the above, and can also communicate with each device in the vehicle by using wired communication. For example, the communication unit 22 can communicate with each device in the vehicle by wired communication via a cable connected to a connection terminal (not illustrated). The communication unit 22 can communicate with each device in the vehicle by a communication method capable of performing digital bidirectional communication at a predetermined communication speed or higher by wired communication such as Universal Serial Bus (USB), High-Definition Multimedia Interface (HDMI) (registered trademark), or Mobile High-Definition Link (MHL).

Here, the in-vehicle device indicates, for example, a device that is not connected to the communication network 41 in the vehicle. As the in-vehicle device, for example, a mobile device or a wearable device possessed by an occupant such as a driver, an information device brought into the vehicle and installed temporarily, or the like is assumed.

The map information accumulation unit 23 accumulates one or both of a map acquired from the outside and a map created in the vehicle 1. For example, the map information accumulation unit 23 accumulates a three-dimensional high-precision map, a global map that has lower precision than the high-precision map and covers a wide area, and the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from an external server or the like. The point cloud map is a map including point clouds (point cloud data). The vector map is, for example, a map in which traffic information such as a traffic lane and a position of a traffic light is associated with the point cloud map and which is adapted to an advanced driver assistance system (ADAS) or autonomous driving (AD).

The point cloud map and the vector map may be provided from, for example, an external server or the like, or may be created in the vehicle 1 as a map for matching with a local map (described later) on the basis of a result of sensing by a camera 51, a radar 52, LiDAR 53, or the like and accumulated in the map information accumulation unit 23. In addition, in a case where a high-precision map is provided from the external server or the like, for example, map data of several hundred meters square which data is related to a planned route on which the vehicle 1 travels from now is acquired from the external server or the like in order to reduce communication capacity.

The position information acquisition unit 24 receives a Global Navigation Satellite System (GNSS) signal from a GNSS satellite, and acquires position information of the vehicle 1. The acquired position information is supplied to the driving assistance/automatic driving control unit 29. Note that the position information acquisition unit 24 is not limited to the method using the GNSS signal, and may acquire the position information by using, for example, a beacon.

The outside recognition sensor 25 includes various sensors used for recognition of a situation outside the vehicle 1, and supplies sensor data from each of the sensors to each unit of the vehicle control system 11. Kinds and the number of sensors included in the outside recognition sensor 25 are arbitrary.

For example, the outside recognition sensor 25 includes the camera 51, the radar 52, the light detection and ranging/laser imaging detection and ranging (LiDAR) 53, and an ultrasonic sensor 54. The outside recognition sensor 25 is not limited to the above and may be configured to include one or more kinds of sensors among the camera 51, the radar 52, the LiDAR 53, and the ultrasonic sensor 54. The number of the cameras 51, radars 52, LiDAR 53, and ultrasonic sensors 54 is not specifically limited as long as being the number that can be practically installed in the vehicle 1. Furthermore, the kinds of sensors included in the outside recognition sensor 25 is not limited to this example, and the outside recognition sensor 25 may include another kind of sensor. An example of a sensing region of each of the sensors included in the outside recognition sensor 25 will be described later.

Note that a photographing method of the camera 51 is not specifically limited. For example, cameras of various photographing methods, such as a time of flight (ToF) camera, a stereo camera, a monocular camera, and an infrared camera that are of photographing methods capable of measuring distance can be applied to the camera 51 as necessary. The camera 51 is not limited to the above and may simply acquire a photographed image regardless of distance measurement.

Furthermore, for example, the outside recognition sensor 25 can include an environment sensor to detect an environment for the vehicle 1. The environment sensor is a sensor to detect an environment such as weather, a meteorological phenomenon, and brightness, and can include various sensors such as a raindrop sensor, a fog sensor, a sunshine sensor, a snow sensor, and an illuminance sensor.

Furthermore, for example, the outside recognition sensor 25 includes a microphone used for detection of a sound around the vehicle 1, a position of a sound source, and the like.

The in-vehicle sensor 26 includes various sensors to detect information inside the vehicle, and supplies sensor data from each of the sensors to each unit of the vehicle control system 11. Kinds and the number of various sensors included in the in-vehicle sensor 26 are not specifically limited as long as being the kinds and numbers that can be practically installed in the vehicle 1.

For example, the in-vehicle sensor 26 can include one or more kinds of sensors among a camera, a radar, a seat occupancy sensor, a steering wheel sensor, a microphone, and a biological sensor. As the camera included in the in-vehicle sensor 26, for example, cameras of various photographing methods capable of measuring a distance, such as a ToF camera, a stereo camera, a monocular camera, and an infrared camera, can be used. The camera included in the in-vehicle sensor 26 is not limited to the above and may simply acquire a photographed image regardless of distance measurement. The biological sensor included in the in-vehicle sensor 26 is provided, for example, on a seat, a steering wheel, or the like, and detects various kinds of biological information of an occupant such as a driver. Details of the in-vehicle sensor 26 will be described later.

The vehicle sensor 27 includes various sensors to detect a state of the vehicle 1, and supplies sensor data from each of the sensors to each unit of the vehicle control system 11. Kinds and the number of various sensors included in the vehicle sensor 27 are not specifically limited as long as being the kinds and numbers that can be practically installed in the vehicle 1.

For example, the vehicle sensor 27 includes a speed sensor, an acceleration sensor, an angular velocity sensor (gyroscope sensor), and an inertial measurement unit (IMU) in which these sensors are integrated. For example, the vehicle sensor 27 includes a steering angle sensor that detects a steering angle of the steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects a rotation speed of an engine or a motor, an air pressure sensor that detects an air pressure of a tire, a slip rate sensor that detects a slip rate of the tire, and a wheel speed sensor that detects a rotation speed of a wheel. For example, the vehicle sensor 27 includes a battery sensor that detects a remaining amount and a temperature of a battery, and an impact sensor that detects an impact from the outside.

The storage unit 28 includes at least one of a nonvolatile storage medium or a volatile storage medium, and stores data and a program. The storage unit 28 is used as, for example, an electrically erasable programmable read-only memory (EEPROM) and a random access memory (RAM). A magnetic storage device such as a hard disc drive (HDD), a semiconductor storage device, an optical storage device, and a magneto-optical storage device can be applied as the storage medium. The storage unit 28 stores various kinds of programs and data used by each unit of the vehicle control system 11. For example, the storage unit 28 includes an event data recorder (EDR) and a data storage system for automated driving (DSSAD), and stores information of the vehicle 1 before and after an event such as an accident and information acquired by the in-vehicle sensor 26.

The driving assistance/automatic driving control unit 29 controls driving assistance and automatic driving of the vehicle 1. For example, the driving assistance/automatic driving control unit 29 includes an analysis unit 61, an action planning unit 62, and an operation control unit 63.

The analysis unit 61 performs analysis processing of the situation of the vehicle 1 and the surroundings. The analysis unit 61 includes an own position estimation unit 71, a sensor fusion unit 72, and a recognition unit 73.

The own position estimation unit 71 estimates an own position of the vehicle 1 on the basis of the sensor data from the outside recognition sensor 25 and the high-precision map accumulated in the map information accumulation unit 23. For example, the own position estimation unit 71 generates a local map on the basis of the sensor data from the outside recognition sensor 25, and estimates the own position of the vehicle 1 by performing matching between the local map and the high-precision map. The position of the vehicle 1 is based on, for example, a center of an axle of a rear wheel pair.

The local map is, for example, a three-dimensional high-precision map created by utilization of a technology such as simultaneous localization and mapping (SLAM), an occupancy grid map, or the like. The three-dimensional high-precision map is, for example, the above-described point cloud map or the like. The occupancy grid map is a map in which a three-dimensional or two-dimensional space around the vehicle 1 is divided into grids (grids) of a predetermined size, and an occupancy state of an object is indicated in units of grids. The occupancy state of the object is indicated by, for example, presence or absence or an existence probability of the object. The local map is also used for detection processing and recognition processing of a situation outside the vehicle 1 by the recognition unit 73, for example.

Note that the own position estimation unit 71 may estimate the own position of the vehicle 1 on the basis of the position information acquired by the position information acquisition unit 24 and the sensor data from the vehicle sensor 27.

The sensor fusion unit 72 performs sensor fusion processing of combining a plurality of different kinds of sensor data (such as image data supplied from the camera 51 and sensor data supplied from the radar 52) and acquiring new information. Methods of combining the different kinds of sensor data include integration, fusion, association, and the like.

The recognition unit 73 executes the detection processing of detecting the situation outside the vehicle 1 and the recognition processing of recognizing the situation outside the vehicle 1.

For example, the recognition unit 73 performs the detection processing and the recognition processing of the situation outside the vehicle 1 on the basis of the information from the outside recognition sensor 25, the information from the own position estimation unit 71, the information from the sensor fusion unit 72, and the like.

Specifically, for example, the recognition unit 73 performs detection processing, recognition processing, and the like of an object around the vehicle 1. The detection processing of an object is, for example, processing of detecting presence/absence, a size, a shape, a position, a motion, and the like of an object. The recognition processing of an object is, for example, processing of recognizing an attribute such as a kind of an object or identifying a specific object. However, the detection processing and the recognition processing are not necessarily divided clearly, and may overlap.

For example, the recognition unit 73 detects an object around the vehicle 1 by performing clustering to classify, into clusters of point clouds, point clouds based on the sensor data from the radar 52, the LiDAR 53, or the like. As a result, the presence/absence, size, shape, and position of an object around the vehicle 1 are detected.

For example, the recognition unit 73 detects the motion of the object around the vehicle 1 by performing tracking that follows the motion of the cluster of the point clouds classified by clustering. As a result, a speed and a traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road surface marking, and the like on the basis of the image data supplied from the camera 51. Furthermore, the recognition unit 73 may recognize a kind of the object around the vehicle 1 by performing recognition processing such as semantic segmentation.

For example, the recognition unit 73 can perform recognition processing of a traffic rule around the vehicle 1 on the basis of the map accumulated in the map information accumulation unit 23, a result of estimation of the own position by the own position estimation unit 71, and a result of recognition of the object around the vehicle 1 by the recognition unit 73. Through this processing, the recognition unit 73 can recognize a position and a state of a traffic light, contents of a traffic sign and road surface marking, contents of traffic regulation, a travelable traffic lane, and the like.

For example, the recognition unit 73 can perform recognition processing of a surrounding environment of the vehicle 1. As the surrounding environment to be recognized by the recognition unit 73, weather, temperature, humidity, brightness, a state of a road surface, and the like are assumed.

The action planning unit 62 creates an action plan of the vehicle 1. For example, the action planning unit 62 creates the action plan by performing processing of global path planning and path following.

Note that the global path planning is processing of planning a rough path from a start to a goal. This global path planning includes processing of performing local path planning enabling safe and smooth traveling in the vicinity of the vehicle 1 in consideration of the motion characteristics of the vehicle 1 in the planned path, which processing is called trajectory planning.

The path following is processing of planning operation for safely and accurately traveling a path planned by the global path planning within planned time. For example, the action planning unit 62 can calculate target speed and target angular velocity of the vehicle 1 on the basis of a result of the path following processing.

The operation control unit 63 controls the operation of the vehicle 1 in order to realize the action plan created by the action planning unit 62.

For example, the operation control unit 63 controls a steering control unit 81, a brake control unit 82, and a drive control unit 83 included in the vehicle control unit 32 (described later), and performs acceleration/deceleration control and direction control in such a manner that the vehicle 1 travels on a trajectory calculated by the trajectory planning. For example, the operation control unit 63 performs cooperative control to realize functions of the ADAS, such as collision avoidance or shock mitigation, follow-up traveling, vehicle speed maintaining traveling, collision warning of the own vehicle, and lane departure warning of the own vehicle. For example, the operation control unit 63 performs cooperative control for the purpose of automatic driving or the like in which traveling is performed autonomously without depending on operation by the driver.

The DMS 30 performs authentication processing of the driver, recognition processing of a state of the driver, and the like on the basis of the sensor data from the in-vehicle sensor 26, input data input by an HMI 31 (described later), and the like. As the state of the driver to be recognized, for example, a physical condition, an arousal level, a concentration degree, a fatigue level, a line-of-sight direction, a drunkenness level, driving operation, a posture, and the like are assumed.

Note that the DMS 30 may perform authentication processing of an occupant other than the driver and recognition processing of a state of the occupant. Furthermore, for example, the DMS 30 may perform recognition processing of a situation inside the vehicle on the basis of the sensor data from the in-vehicle sensor 26. As the situation inside the vehicle to be recognized, for example, temperature, humidity, brightness, a smell, and the like are assumed.

The HMI 31 inputs various kinds of data, instructions, and the like, and presents various kinds of data to the driver and the like.

The data input by the HMI 31 will be schematically described. The HMI 31 includes an input device for a person to input data. The HMI 31 generates an input signal on the basis of data, an instruction, or the like input by the input device, and supplies the input signal to each unit of the vehicle control system 11. The HMI 31 includes operation elements such as a touch panel, a button, a switch, and a lever as the input device. The HMI 31 is not limited to the above and may further include an input device capable of inputting information by a method other than manual operation, such as voice, gesture, or the like. Furthermore, the HMI 31 may use, for example, a remote control device using infrared rays or radio waves, or an external connection device such as a mobile device or a wearable device corresponding to the operation of the vehicle control system 11 as an input device.

Presentation of the data by the HMI 31 will be schematically described. The HMI 31 generates visual information, auditory information, and tactile information for the occupant or the outside of the vehicle. In addition, the HMI 31 performs output control of controlling an output, output contents, output timing, an output. method, and the like of each piece of generated information. As the visual information, the HMI 31 generates and outputs, for example, information indicated by an image or light, such as an operation screen, a display of a state of the vehicle 1, a warning display, and a monitor image indicating a situation around the vehicle 1. Furthermore, as the auditory information, the HMI 31 generates and outputs information indicated by sound, such as voice guidance, a warning sound, and a warning message, for example. Furthermore, the HMI 31 generates and outputs, as the tactile information, information given to a sense of touch of the occupant by force, vibration, motion, or the like, for example.

As an output device through which the HMI 31 outputs the visual information, for example, a display device that presents the visual information by displaying an image by itself or a projector device that presents the visual information by projecting an image can be applied. Note that the display device may be a device that displays the visual information in a field of view of the occupant, such as a head-up display, a transmissive display, or a wearable device having an augmented reality (AR) function in addition to a display device having a normal display. In addition, in the HMI 31, a display device included in a navigation device, an instrument panel, a camera monitoring system (CMS), an electronic mirror, a lamp, or the like provided in the vehicle 1 can also be used as an output device that outputs the visual information.

As an output device through which the HMI 31 outputs the auditory information, for example, an audio speaker, a headphone, or an earphone can be applied.

As an output device through which the HMI 31 outputs the tactile information, for example, a haptic element in which a haptic technology is used can be applied. The haptic element is provided, for example, at a portion with which the occupant of the vehicle 1 comes into contact, such as a steering wheel or a seat.

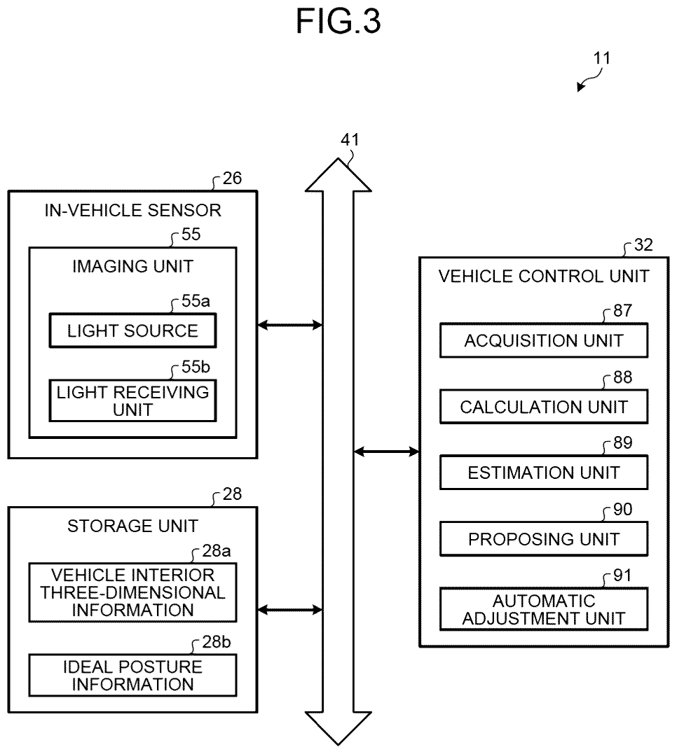

The vehicle control unit 32 controls each unit of the vehicle 1. The vehicle control unit 32 includes the steering control unit 81, the brake control unit 32, the drive control unit 83, a body system control unit 84, a light control unit 85, and a horn control unit 86. In addition, the vehicle control unit 32 according to the embodiment further includes an acquisition unit 87 (see FIG. 3), a calculation unit 88 (see FIG. 3), an estimation unit 89 (see FIG. 3), a proposing unit 90 (see FIGS. 3), and an automatic adjustment unit 91 (see FIG. 3).

The steering control unit 81 detects and controls a state of a steering system of the vehicle 1. The steering system includes, for example, a steering mechanism including a steering wheel and the like, electric power steering, and the like. The steering control unit 81 includes, for example, a steering ECU that controls the steering system, an actuator that drives the steering system, and the like.

The brake control unit 82 performs detection, control, and the like of a state of a brake system of the vehicle 1. The brake system includes, for example, a brake mechanism including a brake pedal or the like, an antilock brake system (ABS), a regenerative brake mechanism, and the like. The brake control unit 82 includes, for example, a brake ECU that controls the brake system, an actuator that drives the brake system, and the like.

The drive control unit 83 performs detection, control, and the like of a state of a drive system of the vehicle 1. The drive system includes, for example, a driving force generation device to generate driving force, such as an accelerator pedal, an internal combustion engine, or a driving motor, a driving force transmission mechanism to transmit the driving force to wheels, and the like. The drive control unit 83 includes, for example, a drive ECU that controls the drive system, an actuator that drives the drive system, and the like.

The body system control unit 84 performs detection, control, and the like of a state of a body system of the vehicle 1. The body system includes, for example, a keyless entry system, a smart key system, a power window device, a power seat, an air conditioner device, an airbag, a seat belt, a shift lever, and the like. The body system control unit 84 includes, for example, a body system ECU that controls the body system, an actuator that drives the body system, and the like.

The light control unit 35 performs detection, control, and the like of states of various lights of the vehicle 1. As the lights to be controlled, for example, a headlight, a backlight, a fog light, a turn signal, a brake light, projection, a display of a bumper, and the like are assumed. The light control unit 85 includes a light ECU that controls the lights, an actuator that drives the lights, and the like.

The horn control unit 86 performs detection, control, and the like of a state of a car horn of the vehicle 1. The horn control unit 86 includes, for example, a horn ECU that controls the car horn, an actuator that drives the car horn, and the like.

Details of the vehicle control unit 32 according to the embodiment which details include the acquisition unit 87, the calculation unit 88, the estimation unit 89, the proposing unit 90, and the automatic adjustment unit 91 not illustrated in FIG. 1 will be described later.

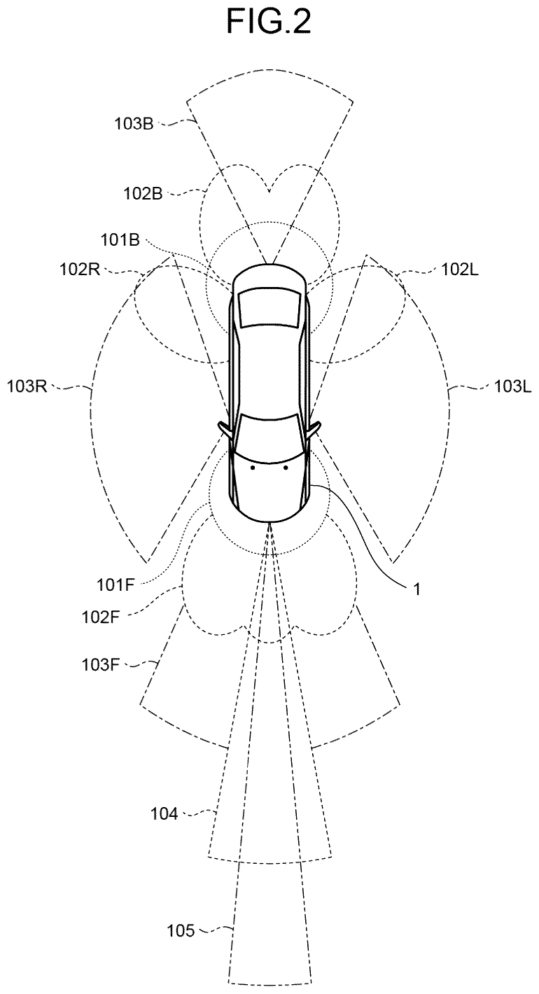

FIG. 2 is a view illustrating examples of sensing regions by the camera 51, the radar 52, the LiDAR 53, the ultrasonic sensor 54, and the like of the outside recognition sensor 25 in FIG. 1. Note that a state in which the vehicle 1 is viewed from the above is schematically illustrated in FIG. 2, a left end side being a front end (front) side of the vehicle 1 and a right end side being a rear end (rear) side of the vehicle 1.

A sensing region 101F and a sensing region 101B indicate examples of the sensing regions of the ultrasonic sensor 54. The sensing region 101F covers a periphery of the front end of the vehicle 1 by a plurality of the ultrasonic sensors 54. The sensing region 101B covers a periphery of the rear end of the vehicle 1 by the plurality of ultrasonic sensors 54.

Results of sensing in the sensing region 101F and the sensing region 101B are used, for example, for parking assistance of the vehicle 1.

A sensing region 102F to a sensing region 102B indicate examples of sensing regions of the radar 52 for a short distance or a middle distance. The sensing region 102F covers a farther position than the sensing region 101F on a front side of the vehicle 1. The sensing region 102B covers a farther position than the sensing region 101B on a rear side of the vehicle 1. A sensing region 102L covers a rear periphery of a left side surface of the vehicle 1. A sensing region 102R covers a rear periphery of a right side surface of the vehicle 1.

A result of sensing in the sensing region 102F is used, for example, to detect a vehicle, a pedestrian, or the like existing in front of the vehicle 1. A result of sensing in the sensing region 102B is used, for example, for a collision prevention function or the like on the rear side of the vehicle 1. Results of sensing in the sensing region 102L and the sensing region 102R are used, for example, for detection of an object in a blind spot on a side of the vehicle 1.

A sensing region 103F to a sensing region 103B indicate examples of sensing regions by the camera 51. The sensing region 103F covers a farther position than the sensing region 102F on the front side of the vehicle 1. The sensing region 103B covers a farther position than the sensing region 102B on the rear side of the vehicle 1. A sensing region 103L covers a periphery of the left side surface of the vehicle 1. A sensing region 103R covers a periphery of the right side surface of the vehicle 1.

A result of sensing in the sensing region 103F can be used, for example, for recognition of a traffic light or a traffic sign, a traffic lane departure prevention assistance system, and an automatic headlight control system. A result of sensing in the sensing region 103B can be used, for example, for parking assistance and a surround view system. Results of sensing in the sensing region 103L and the sensing region 103R can be used for the surround view system, for example.

A sensing region 104 indicates an example of a sensing region of the LiDAR 53. The sensing region 104 covers a farther position than the sensing region 103F on the front side of the vehicle 1. On the other hand, the sensing region 104 has a narrower range in a left-right direction than the sensing region 103F.

A result of sensing in the sensing region 104 is used, for example, to detect an object such as a surrounding vehicle.

A sensing region 105 indicates an example of a sensing region of the radar 52 for a long range. The sensing region 105 covers a farther position than the sensing region 104 on the front side of the vehicle 1. On the other hand, the sensing region 105 has a narrower range in the left-right direction than the sensing region 104.

A result of sensing in the sensing region 105 is used, for example, for adaptive cruise control (ACC), emergency braking, collision avoidance, and the like.

Note that the sensing regions of the sensors of the camera 51, the radar 52, the LiDAR 53, and the ultrasonic sensor 54 included in the outside recognition sensor 25 may have various configurations other than those in FIG. 2. Specifically, the ultrasonic sensor 54 may also sense the sides of the vehicle 1, or the LiDAR 53 may sense the rear side of the vehicle 1. In addition, the installation position of each of the sensors is not limited to each example described above. Furthermore, the number of each kind of sensors may be one or more.

### Details of Control Processing

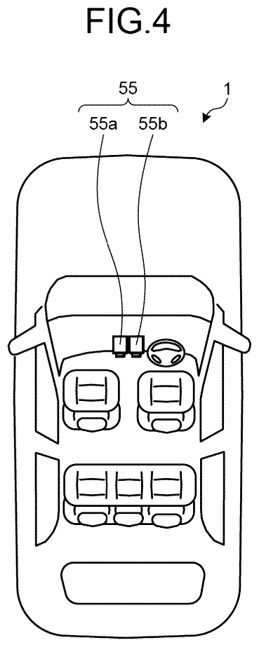

Next, details of the control processing according to the embodiment will be described with reference to FIG. 3 to FIG. 8. FIG. 3 is a block diagram illustrating a detailed configuration example of the vehicle control system 11 according to the embodiment of the present disclosure, and FIG. 4 is a view illustrating an example of an arrangement of an imaging unit 55 according to the embodiment of the present disclosure.

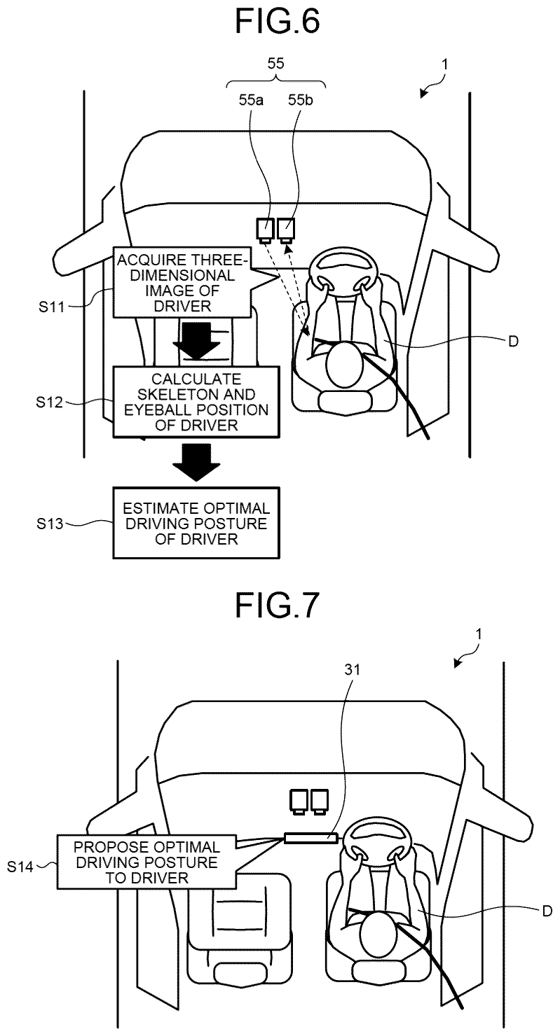

As illustrated in FIG. 3, the in-vehicle sensor 26 according to the embodiment includes the imaging unit 55. The imaging unit 55 can capture a three-dimensional image of a driver D (see FIG. 6) in a driver seat of the vehicle 1. Note that in the present disclosure, the “three-dimensional image” is an image generated by association of distance information (depth information) acquired for each pixel with position information of the corresponding pixel.

The imaging unit 55 is, for example, a time of flight (ToF) sensor, a sensor that performs distance measurement by using a structured light method, a stereo camera, or the like.

Furthermore, the imaging unit 55 preferably includes a light source 55a and a light receiving unit 55b. The light source 55a emits light toward the driver D. The light emitted from the light source 55a is, for example, infrared light. The light receiving unit 55b receives light emitted from the light source 55a and reflected by the driver D.

For example, as illustrated in FIG. 4, the imaging unit 55 is located on the front side inside of the vehicle 1 (for example, near a ceiling on the front side of the vehicle, near an overhead console, or the like), and is installed in such a manner that a predetermined region in the vehicle (such as the driver seat and a periphery thereof) is an observation region.

The description returns to FIG. 3. The storage unit 28 includes vehicle interior three-dimensional information 28a and ideal posture information 28b. Information related to a three-dimensional shape of the vehicle interior of the vehicle 1 is registered in the vehicle interior three-dimensional information 28a.

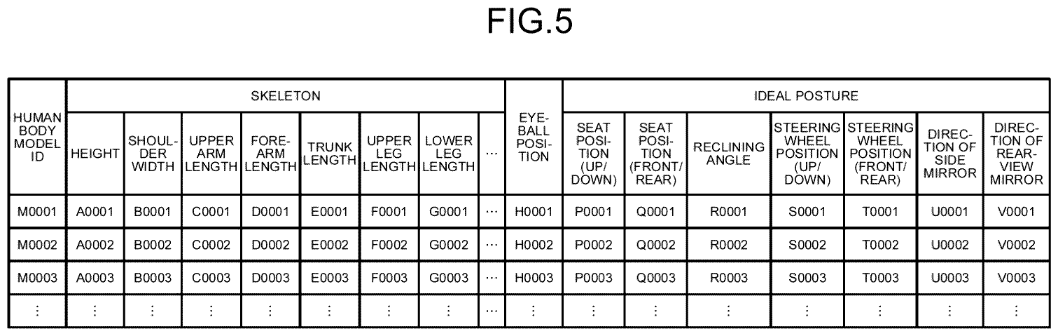

Information related to an ideal driving posture in the vehicle 1 is registered in the ideal posture information 28b. FIG. 5 is a view illustrating an example of the ideal posture information 28b according to the embodiment of the present disclosure. As illustrated in FIG. 5, a human body model ID, information related to a skeleton, information related to an eyeball position, and the information related to the ideal posture are registered in the ideal posture information 28b in association with each other.

Here, the human body model ID is an identifier to identify various human body models having various body shapes.

The information related to the skeleton is information indicating the skeleton of the human body model indicated by the associated human body model ID. The information related to the skeleton includes, for example, a height, a shoulder width, an upper arm length, a forearm length, a trunk length, an upper leg length, and a lower leg length of the human body model.

The information related to the eyeball position is information indicating a position of eyeballs of the human body model indicated by the associated human body model ID.

The information related to the ideal posture is information indicating a seat position, a steering wheel position, a mirror position, and the like at which an ideal driving posture can be acquired in a case where the human body model indicated by the associated human body model ID is seated on the driver seat of the vehicle 1.

Such an ideal posture is determined on the basis of, for example, ergonomics. Note that in the present disclosure, the seat position of the driver seat is indicated in a case where the term “seat position” is simply described, and positions (directions) of side mirrors and a rearview mirror are indicated in a case where the term “mirror position” is simply described.

The information related to the ideal posture includes, for example, a seat position (up/down), a seat position (front/rear), a reclining angle, a steering wheel position (up/down), a steering wheel position (front/rear), a direction of side mirrors, a direction of a rearview mirror, and the like.

The description returns to FIG. 3. The vehicle control unit 32 includes the acquisition unit 87, the calculation unit 88, the estimation unit 89, the proposing unit 90, and the automatic adjustment unit 91, and realizes or executes a function and an action of the control processing described below.

Note that an internal configuration of the vehicle control unit 32 is not limited to the configuration illustrated in FIG. 3, and may be another configuration as long as the control processing (described later) is performed. In FIG. 3, illustration of the steering control unit 81 (see FIG. 1) to the horn control unit 86 (see FIG. 1) included in the vehicle control unit 32 is omitted.

A function of each unit in the vehicle control unit 32 will be described with reference to FIG. 6 to FIG. 8. FIG. 6 to FIG. 8 are views for describing an example of processing executed by the vehicle control system 11 according to the embodiment of the present disclosure.

First, as illustrated in FIG. 6, the acquisition unit 87 (see FIG. 3) images the driver D seated in the driver seat of the vehicle 1 by the imaging unit 55, and acquires a three-dimensional image of the driver D (Step S11).

Then, the calculation unit 88 (see FIG. 3) converts the three-dimensional image of the driver D which image is acquired by the acquisition unit 87 into three-dimensional information of the driver D, and calculates the skeleton and the eyeball position of the driver D on the basis of the three-dimensional information of the driver D (Step S12).

Thus, the calculation unit 88 can accurately calculate a height, a shoulder width, an upper arm length, a forearm length, a trunk length, an upper leg length, an eyeball position, and the like of the driver D.

Note that in the present disclosure, the three-dimensional information is three-dimensional coordinate information (specifically, an aggregate of a plurality of pieces of three-dimensional coordinate information) in a real space which information is generated by conversion of position information of a pixel in the above-described three-dimensional image into coordinates in the real space and association with distance information corresponding to the coordinates acquired by the conversion.

Furthermore, in the processing of Step S12, in a case where the imaging unit 55 is installed only on the front side inside the vehicle 1, it is difficult to image a part below knees of the driver D.

Thus, in a case where the imaging unit 55 is installed only on the front side inside the vehicle 1, the calculation unit 88 may estimate the lower leg length of the driver D on the basis of the lengths of the other parts and information related to an average body shape registered in advance. Thus, another imaging unit 55 is unnecessary, and it is possible to reduce a cost of the vehicle control system 11.

On the other hand, in the present disclosure, another imaging unit 55 that images a part below the knees of the driver D, may be provided and the lower leg length of the driver D may be directly calculated. Thus, the lower leg length of the driver D can be accurately calculated.

Then, the estimation unit 89 (see FIG. 3) estimates an optimal driving posture of the driver D on the basis of the information related to the skeleton and the eyeball position of the driver D which information is calculated by the calculation unit 88, and the information registered in the ideal posture information 28b (see FIG. 3) (Step S13).

For example, the estimation unit 89 specifies one human body model having parameters of the skeleton and the eyeball position which parameters are the closest to parameters of the skeleton and the eyeball position of the driver D from a plurality of the human body models registered in the ideal posture information 28b.

Then, as various parameters (seat position, steering wheel position, and mirror position) with which the driver D can acquire the optimal driving posture, the estimation unit 89 estimates the various parameters related to the ideal posture associated with the human body model specified to be the closest to the driver D.

As described above, in the embodiment, the three-dimensional information of the driver D is calculated by utilization of the imaging unit 55 capable of acquiring the three-dimensional image, and the optimal driving posture of the driver D is estimated on the basis of the three-dimensional information of the driver D.

As a result, it is possible to acquire skeleton information and information related to the eyeball position with high accuracy as compared with a case where the optimal driving posture of the driver D is estimated on the basis of two-dimensional information. Thus, it is possible to estimate the more optimal driving posture of the driver D. Thus, according to the embodiment, the driver D can drive the vehicle 1 in the more optimal posture.

Note that although the example of estimating the optimal driving posture of the driver D on the basis of the ideal posture information 28b that is table information in which the skeleton and the eyeball position of the human body model and the information related to the ideal posture are associated with each other has been described in the above embodiment, the present disclosure is not limited to such an example.

For example, the estimation unit 89 may estimate, as an optimal seat height, a seat height that minimizes a blind spot of the driver D on the basis of the skeleton and the eyeball position of the driver D, which skeleton and eyeball position are calculated by the calculation unit 88, and the vehicle interior three-dimensional information 28a.

Furthermore, the estimation unit 89 may estimate a front/rear seat position where the driver D can operate the accelerator pedal and the brake pedal most comfortably as an optimal front/rear seat position on the basis of the skeleton of the driver D which skeleton is calculated by the calculation unit 88 and the vehicle interior three- dimensional information 28a.

Furthermore, the estimation unit 89 may estimate a reclining angle and a steering wheel position at which the driver D can operate the steering wheel most comfortably as an optimal reclining angle and steering wheel position on the basis of the skeleton of the driver D which skeleton is calculated by the calculation unit 88 and the vehicle interior three-dimensional information 28a.

As described above, also by the estimation processing based on the vehicle interior three-dimensional information 28a, the optimal driving posture of the driver D can be estimated on the basis of the three-dimensional information of the driver D. Thus, the driver D can drive the vehicle 1 in the more optimal posture.

Furthermore, the estimation unit 89 may estimate the optimal driving posture of the driver D in the vehicle 1 on the basis of the three-dimensional information of the driver D which information is calculated by the calculation unit 88 and an ideal posture model (not illustrated) generated in advance by machine learning.

The learned ideal posture model includes a deep neural network (DNN), a support vector machine, and the like in which an ideal driving posture and the like of the driver D are learned by utilization of learning data. When the three-dimensional information of the driver D is input, the learned ideal posture model outputs a discrimination result, that is, various kinds of information related to the optimal driving posture of the driver D in the vehicle 1.

Also by the above, the optimal driving posture of the driver D can be estimated on the basis of the three-dimensional information of the driver D, whereby the driver D can drive the vehicle 1 in the more optimal posture.

The description of the processing executed by the vehicle control system 11 will be continued. Then, as illustrated in FIG. 7, the proposing unit 90 (see FIG. 3) proposes the optimal driving posture of the driver D which posture is estimated by the estimation unit 89 (see FIG. 3) to the driver D (Step S14).

For example, the proposing unit 90 proposes the optimal driving posture to the driver D by presenting the optimal driving posture to the HMI 31. Furthermore, the proposing unit 90 may propose the optimal driving posture to the driver D by voice guidance output from the HMI 31, for example.

For example, the proposing unit 90 proposes “Raise the seat by 3 cm more.”, “Move the steering wheel position further away from the body for 2 cm.”, and “Turn the left side mirror inward by 10 degrees.” to the driver D.

Furthermore, the proposing unit 90 acquires information related to the seat position, the steering wheel position, and the mirror position of the vehicle 1 in real time, and feeds back the real-time position information to the contents of proposal to the driver D. As a result, the seat position, the steering wheel position, and the mirror position of the vehicle 1 can be efficiently set at optimal positions.

As described above, the proposing unit 90 proposes the optimal driving posture to the driver D. Thus, the driver D can drive the vehicle 1 in the more optimal posture even in the vehicle 1 in which the seat position, the steering wheel position, and the mirror position cannot be automatically adjusted.

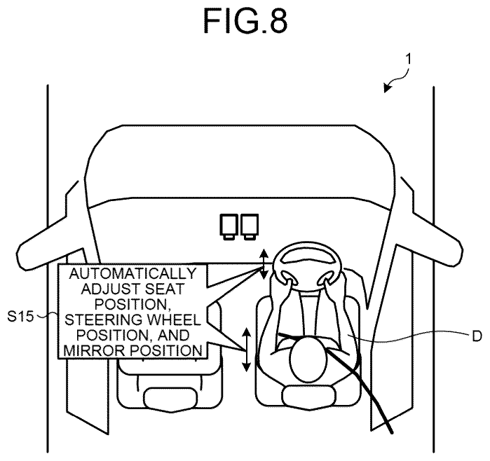

In addition, in the embodiment, as illustrated in FIG. 8, the automatic adjustment unit 91 (see FIG. 3) may automatically adjust the seat position, the steering wheel position, and the mirror position on the basis of the optimal driving posture of the driver D which posture is estimated by the estimation unit 89 (see FIG. 3) (Step S15). The processing in Step S15 can be executed in the vehicle 1 in which the seat position, the steering wheel position, and the mirror position can be automatically adjusted.

As a result, the driver D can drive the vehicle 1 in the more optimal posture without manually adjusting the seat and the like.

Note that in the present disclosure, only one of the proposal processing by the proposing unit 90 and the automatic adjustment processing by the automatic adjustment unit 91 may be performed, or both of the two kinds of processing may be performed.

For example, in the vehicle 1 in which the seat position and the mirror position can be automatically adjusted while the steering wheel position cannot be automatically adjusted, an optimal steering wheel position may be proposed to the driver D while the seat position and the mirror position are automatically adjusted. As a result, the technology of the present disclosure can be applied to many vehicle types.

Furthermore, the imaging unit 55 preferably includes the light source 55a in the embodiment. This makes it possible to accurately acquire the three-dimensional information of the driver D even in a situation with little external light, for example, at night.

Thus, according to the embodiment, the driver D can drive the vehicle 1 in the more optimal posture even in the situation with little external light, for example, at night. Note that the present disclosure is not limited to a case where the imaging unit 55 includes the light source 55a, and the light source 55a may not be included.

In addition, the light source 55a is preferably a light source that emits infrared light in the embodiment. As a result, the three-dimensional information of the driver D can be acquired more accurately. Note that in the present disclosure, the light source 55a is not limited to the light source that emits infrared light, and may be a light source that emits visible light, ultraviolet light, or the like.

In the embodiment, preferably, the three- dimensional information of the driver D is converted into the information related to the skeleton and the information related to the eyeball position, and the optimal driving posture of the driver D is estimated on the basis of the information. As a result, since an information amount can be greatly reduced as compared with a case where the optimal driving posture of the driver D is directly estimated from the three-dimensional information of the driver D, a processing load of the vehicle control unit 32 can be reduced.

In addition, in the embodiment, in a case where the driving posture of the driver D optimally adjusted once gradually collapses during driving or the like, the optimal driving posture may be proposed to the driver D again. Such collapse of the driving posture can be detected, for example, by constant monitoring of the driving posture by the imaging unit 55.

As a result, the driver D can keep driving the vehicle 1 in the more optimal posture.

Although the example in which the estimation unit 89 estimates the optimal driving posture of the driver D has been described in the embodiment described above, the present disclosure is not limited to such an example.

For example, in the present disclosure, the estimation unit 89 may estimate a seat position and a steering wheel position suitable for the driver D to get on and get off on the basis of the three-dimensional information of the driver D. In this case, the automatic adjustment unit 91 may automatically adjust the seat position and the steering wheel position on the basis of the seat position and the steering wheel position suitable for the driver D to get on and off the vehicle.

As a result, the driver D can easily get on and off the driver seat of the vehicle 1. Note that information related to the ideal seat position and steering wheel position at the time of getting on and off the vehicle is preferably stored in the storage unit 28 in advance.

Furthermore, in the present disclosure, the estimation unit 89 may estimate a comfortable driving posture of the driver D during automatic driving of the vehicle 1 on the basis of the three-dimensional information of the driver D. In this case, the automatic adjustment unit 91 may automatically adjust the seat position and the like on the basis of the comfortable seat position and the like of the driver D during the automatic driving.

As a result, the driver D can spend time comfortably during the automatic driving of the vehicle 1. Note that information related to the ideal seat position and the like during the automatic driving is preferably stored in the storage unit 28 in advance.

### Procedure of Control Processing

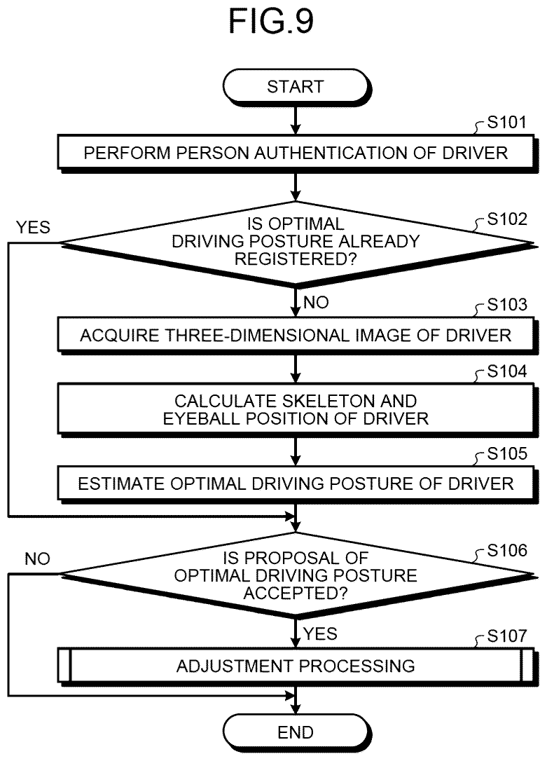

Next, the procedure of the control processing according to the embodiment will be described with reference to FIG. 9 to FIG. 11. FIG. 9 is a flowchart illustrating an example of the procedure of the control processing executed by the vehicle control system 11 according to the embodiment of the present disclosure.

First, the vehicle control unit 32 performs person authentication of the driver D by using a known technology (Step $101). Then, the vehicle control unit 32 determines whether the optimal driving posture is already registered for the driver D on which the person authentication is performed (Step S102).

Then, in a case where the optimal driving posture of the driver D on which the person authentication is performed is already registered (Step S102, Yes), the processing proceeds to Step $106 described later. On the other hand, in a case where the optimal driving posture of the driver D on which the person authentication is performed is not registered yet (Step S102, No), the vehicle control unit 32 acquires a three-dimensional image of the driver D seated on the driver seat by using the imaging unit 55 (Step S103).

Then, the vehicle control unit 32 converts the three-dimensional image of the driver D into three-dimensional information of the driver D, and calculates the skeleton and the eyeball position of the driver D on the basis of the three-dimensional information of the driver D (Step S104).

Then, the vehicle control unit 32 estimates the optimal driving posture of the driver D on the basis of the skeleton and the eyeball position of the driver D, and the ideal posture information 28b (Step S105). Then, the vehicle control unit 32 inquires of the driver D whether to accept the proposal of the optimal driving posture (Step S106).

Then, in a case where the driver D accepts the proposal of the optimal driving posture (Step S106, Yes), the vehicle control unit 32 performs adjustment processing of the driving posture (Step S107) and ends the series of control processing. Details of the processing in Step S107 will be described later.

On the other hand, in a case where the driver D refuses the proposal of the optimal driving posture (Step S106, No), the series of control processing is ended.

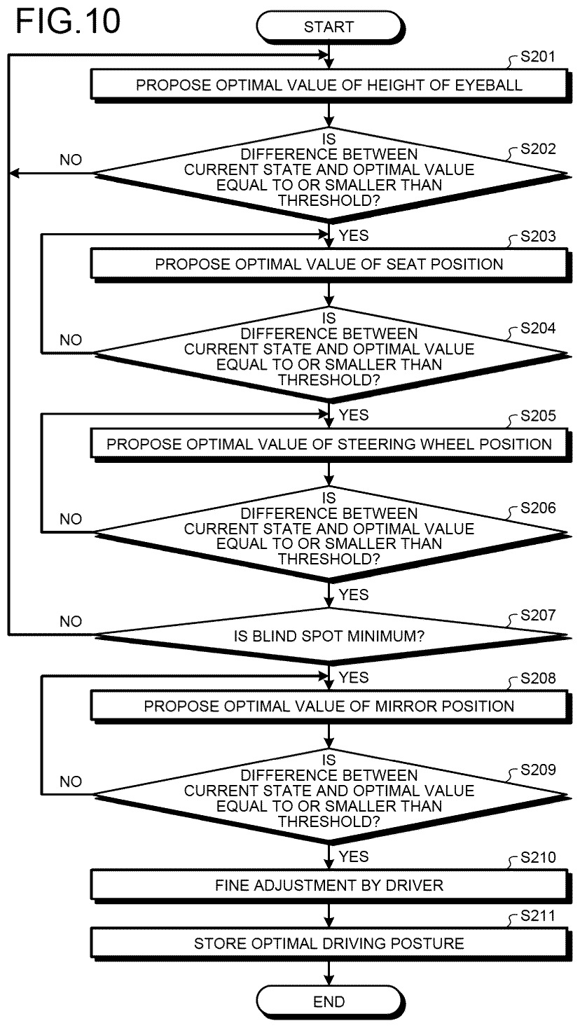

FIG. 10 is a flowchart illustrating an example of a procedure of the adjustment processing executed by the vehicle control system 11 according to the embodiment of the present disclosure.

First, the vehicle control unit 32 proposes, to the driver D, an optimal value of a height of the eyeballs of the driver D on the basis of the optimal driving posture of the driver D which posture is estimated in the processing in Step S105 described above (Step S201). On the basis of this processing, the driver D adjusts a height of the driver seat.

Then, the vehicle control unit 32 determines whether a difference between the current height of the eyeballs and the optimal value of the height of the eyeballs is equal to or smaller than a predetermined threshold (Step S202).

In a case where the difference between the current height of the eyeballs and the optimal value of the height of the eyeballs is equal to or smaller than the predetermined threshold (Step S202, Yes), the vehicle control unit 32 proposes the optimal value of the seat position in a front-rear direction to the driver D (Step S203). On the basis of this processing, the driver D adjusts the front/rear position of the driver seat.

The processing of Step S203 is performed on the basis of the optimal driving posture of the driver D which posture is estimated in the processing of Step S105 described above. On the other hand, in a case where the difference between the current height of the eyeballs and the optimal value of the height of the eyeballs is not equal to or smaller than the predetermined threshold (Step S202, No), the processing returns to Step S201.

Subsequent to the processing in Step S203, the vehicle control unit 32 determines whether a difference between a current seat position in the front-rear direction and an optimal value of the seat position is equal to or smaller than a predetermined threshold (Step S204).

Then, in a case where the difference between the current seat position in the front-rear direction and the optimal value of the seat position is equal to or smaller than the predetermined threshold (Step S204, Yes), the vehicle control unit 32 proposes an optimal value of the steering wheel position in the front-rear direction and an up-down direction to the driver D (Step S205). On the basis of this processing, the driver D adjusts the steering wheel position in the front-rear direction and the up-down direction.

The processing of Step S205 is performed on the basis of the optimal driving posture of the driver D which posture is estimated in the processing of Step S105 described above. On the other hand, in a case where the difference between the current seat position in the front-rear direction and the optimal value of the seat position is not equal to or smaller than the predetermined threshold (Step S204, No), the processing returns to Step S203.

Subsequent to the processing of Step S205, the vehicle control unit 32 determines whether a difference between a current steering wheel position and an optimal value of the steering wheel position is equal to or smaller than a predetermined threshold (Step S206).

Then, in a case where the difference between the current steering wheel position and the optimal value of the steering wheel position is equal to or smaller than the predetermined threshold (Step S206, Yes), the vehicle control unit 32 determines whether a state in which the blind spot of the driver D is the minimum is maintained (Step S207).

The processing in Step S207 is performed on the basis of, for example, the eyeball position of the driver D and the vehicle interior three-dimensional information 28a. On the other hand, in a case where the difference between the current steering wheel position and the optimal value of the steering wheel position is not equal to or smaller than the predetermined threshold (Step S206, No), the processing returns to Step S205.

In the processing of Step S207, in a case where the state in which the blind spot of the driver D is the minimum is maintained (Step S207, Yes), the vehicle control unit 32 proposes an optimal value of the mirror position to the driver D (Step S208). On the basis of this processing, the driver D adjusts the direction of side mirrors and the direction of the rearview mirror.

The processing of Step S208 is performed on the basis of the optimal driving posture of the driver D which posture is estimated in the processing of Step S105 described above. On the other hand, in the processing of Step S207, in a case where the state in which the blind spot of the driver D is the minimum is not maintained (Step S207, No), the processing returns to Step S201.

Subsequent to the processing of Step S208, the vehicle control unit 32 determines whether a difference between a current mirror position and an optimal value of the mirror position is equal to or smaller than a predetermined threshold (Step S209).

In a case where the difference between the current mirror position and the optimal value of the mirror position is equal to or smaller than the predetermined threshold (Step S209, Yes), the vehicle control unit 32 causes the driver D to finely adjust the driving posture (Step S210).

On the other hand, in a case where the difference between the current mirror position and the optimal value of the mirror position is not equal to or smaller than the predetermined threshold (Step S209, No), the processing returns to Step S208.

Subsequent to the processing of Step S210, the vehicle control unit 32 stores the optimal driving posture of the driver D which posture is adjusted by the above-described processing into the storage unit 28 (Step S211), and ends the series of adjustment processing.

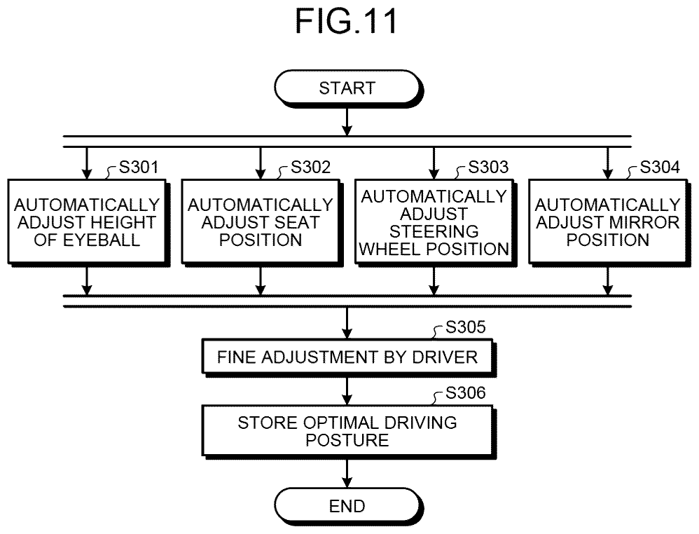

FIG. 11 is a flowchart illustrating another example of the procedure of the adjustment processing executed by the vehicle control system 11 according to the embodiment of the present disclosure.

First, the vehicle control unit 32 automatically adjusts the height of the eyeballs of the driver D on the basis of the optimal driving posture of the driver D which posture is estimated in the processing in Step S105 described above (Step S301). In this processing, the vehicle control unit 32 automatically adjusts the height of the eyeballs of the driver D by automatically adjusting the height of the driver seat.

In parallel with the processing of Step S301, the vehicle control unit 32 automatically adjusts the seat position in the front-rear direction on the basis of the optimal driving posture of the driver D which posture is estimated in the processing of Step S105 described above (Step S302).

In parallel with the processing of Step S301 and Step S302, the vehicle control unit 32 automatically adjusts the steering wheel position in the front-rear direction and the up-down direction on the basis of the optimal driving posture of the driver D which posture is estimated in the processing of Step $105 described above (Step S303).

In parallel with the processing of Step S301 to Step S303, the vehicle control unit 32 automatically adjusts the mirror position on the basis of the optimal driving posture of the driver D which posture is estimated in the processing of Step S105 described above (Step S304).

Then, the vehicle control unit 32 causes the driver D to finely adjust the driving posture (Step S305). Then, the vehicle control unit 32 stores the optimal driving posture of the driver D which posture is adjusted by the above-described processing into the storage unit 28 (Step S306), and ends the series of adjustment processing.

### [Effect]

The information processing device (vehicle control unit 32) according to the embodiment includes the calculation unit 88 and the estimation unit 89. The calculation unit 88 calculates the three-dimensional information of the driver D on the basis of the information from the imaging unit 55 mounted on the vehicle 1. The estimation unit 89 estimates the optimal driving posture of the driver D on the basis of the three-dimensional information.

As a result, the driver D can drive the vehicle 1 in the more optimal posture.

Furthermore, the information processing device (vehicle control unit 32) according to the embodiment further includes the proposing unit 90 that proposes the estimated optimal driving posture to the driver D.

As a result, even in the vehicle 1 in which the seat position, the steering wheel position, and the mirror position cannot be automatically adjusted, the driver D can drive the vehicle 1 in the more optimal posture.

Furthermore, the information processing device (vehicle control unit 32) according to the embodiment further includes the automatic adjustment unit 91 that automatically adjusts the seat position, the steering wheel position, and the mirror position of the vehicle on the basis of the estimated optimal driving posture.

As a result, the driver D can drive the vehicle 1 in the more optimal posture without manually adjusting the seat and the like.

Furthermore, in the information processing device (vehicle control unit 32) according to the embodiment, the estimation unit 89 estimates the optimal driving posture of the driver D on the basis of the three-dimensional information, and the ideal posture information 28b set in advance.

As a result, the optimal driving posture of the driver D can be accurately estimated.

Furthermore, in the information processing device (vehicle control unit 32) according to the embodiment, the estimation unit 89 estimates the optimal driving posture of the driver D on the basis of the three-dimensional information, and the ideal posture model generated by machine learning.

As a result, the optimal driving posture of the driver D can be accurately estimated.

Furthermore, in the information processing device (vehicle control unit 32) according to the embodiment, the imaging unit 55 includes the light source 55a that emits light toward the driver D, and the light receiving unit 55b that receives light reflected by the driver D.

As a result, the driver D can drive the vehicle 1 in the more optimal posture even in a situation with little external light, for example, at night.

Furthermore, in the information processing device (vehicle control unit 32) according to the embodiment, the light source 55a emits infrared light toward the driver D.

As a result, the three-dimensional information of the driver D can be acquired more accurately.

Furthermore, in the information processing device (vehicle control unit 32) according to the embodiment, the calculation unit 88 calculates the skeleton of the driver D and the eyeball position of the driver D as the three-dimensional information of the driver D on the basis of the information from the imaging unit 55.

As a result, a processing load of the vehicle control unit 32 can be reduced.

Furthermore, in the information processing device (vehicle control unit 32) according to the embodiment, the estimation unit 89 estimates, on the basis of the three-dimensional information, the seat position and the steering wheel position of the vehicle 1 which positions are suitable for the driver D to get on and off the vehicle.

As a result, the driver D can easily get on and off the driver seat of the vehicle 1.

Furthermore, in the information processing device (vehicle control unit 32) according to the embodiment, the estimation unit 89 estimates the comfortable driving posture of the driver D during the automatic driving of the vehicle 1 on the basis of the three-dimensional information.

As a result, the driver D can spend time comfortably during the automatic driving of the vehicle 1.

Furthermore, the information processing method according to the embodiment is an information processing method executed by a computer, and includes a calculation step (Step S12 and S104) and an estimation step (Step S13 and S105). In the calculation step (Step S12 and S104), the three-dimensional information of the driver D is calculated on the basis of the information from the imaging unit 55 mounted on the vehicle 1. In the estimation step (Step S13 and S105), the optimal driving posture of the driver D is estimated on the basis of the three-dimensional information.

As a result, the driver D can drive the vehicle 1 in the more optimal posture.

Furthermore, the vehicle control system 11 according to the embodiment includes the imaging unit 55 mounted on the vehicle 1, and the control unit (vehicle control unit 32) that controls the vehicle 1. The control unit (vehicle control unit 32) includes the calculation unit 88 and the estimation unit 89. The calculation unit 88 calculates the three-dimensional information of the driver D on the basis of the information from the imaging unit 55 mounted on the vehicle 1. The estimation unit 89 estimates the optimal driving posture of the driver D on the basis of the three-dimensional information.

As a result, the driver D can drive the vehicle 1 in the more optimal posture.

Although an embodiment of the present disclosure has been described above, the technical scope of the present disclosure is not limited to the above-described embodiment as it is, and various modifications can be made within the spirit and scope of the present disclosure. In addition, components of different embodiments and modification examples may be arbitrarily combined.

Furthermore, effects described in the present description are merely examples and are not limitations, and there may be another effect.

Note that the present technology can also have the following configurations.

(1)

An information processing device comprising:
a calculation unit that calculates three-dimensional information of a driver on a basis of information from an imaging unit mounted on a vehicle; and
an estimation unit that estimates an optimal driving posture of the driver on a basis of the three-dimensional information.
   (2)

The information processing device according to the above (1), further comprising
a proposing unit that proposes the estimated optimal driving posture to the driver.
   (3)

The information processing device according to the above (1) or (2), further comprising
an automatic adjustment unit that automatically adjusts a seat position, a steering wheel position, and a mirror position of the vehicle on a basis of the estimated optimal driving posture.
   (4)

The information processing device according to any one of the above (1) to (3), wherein
the estimation unit estimates the optimal driving posture of the driver on a basis of the three-dimensional information, and ideal posture information set in advance.
   (5)

The information processing device according to any one of the above (1) to (3), wherein
the estimation unit estimates the optimal driving posture of the driver on a basis of the three-dimensional information, and an ideal posture model generated by machine learning.
   (6)

The information processing device according to any one of the above (1) to (5), wherein
the imaging unit includes a light source that emits light toward the driver, and a light receiving unit that receives light reflected by the driver.
   (7)

The information processing device according to the above (6), wherein
the light source emits infrared light toward the driver.
   (8)

The information processing device according to any one of the above (1) to (7), wherein
the calculation unit calculates a skeleton of the driver and an eyeball position of the driver as the three-dimensional information of the driver on a basis of the information from the imaging unit.
   (9)

The information processing device according to any one of the above (1) to (8), wherein
the estimation unit estimates, on a basis of the three-dimensional information, a seat position and a steering wheel position of the vehicle which positions are suitable for the driver to get on and off the vehicle.
   (10)

The information processing device according to any one of the above (1) to (9), wherein

the estimation unit estimates a comfortable driving posture of the driver during automatic driving of the vehicle on a basis of the three-dimensional information.
(11)

An information processing method executed by a computer, the method comprising:
a calculation step of calculating three-dimensional information of a driver on a basis of information from an imaging unit mounted on a vehicle; and
an estimation step of estimating an optimal driving posture of the driver on a basis of the three-dimensional information.
   (12)

The information processing method according to the above (11), further comprising
a proposal step of proposing the estimated optimal driving posture to the driver.
   (13)

The information processing method according to the above (11) or (12), further comprising
an automatic adjustment step of automatically adjusting the seat position, the steering wheel position, and the mirror position of the vehicle on the basis of the estimated optimal driving posture.
   (14)

The information processing method according to any one of the above (11) to (13), wherein
in the estimation step, the optimal driving posture of the driver is estimated on the basis of the three-dimensional information, and ideal posture information set in advance.
   (15)

The information processing method according to any one of the above (11) to (13), wherein
in the estimation step, the optimal driving posture of the driver is estimated on the basis of the three-dimensional information, and an ideal posture model generated by machine learning.
   (16)

The information processing method according to any one of the above (11) to (15), wherein
the imaging unit includes a light source that emits light toward the driver, and a light receiving unit that receives light reflected by the driver.
   (17)

The information processing method according to the above (16), wherein
the light source emits infrared light toward the driver.
   (18)

The information processing method according to any one of the above (11) to (17), wherein
in the calculation step, a skeleton of the driver and an eyeball position of the driver are calculated as the three-dimensional information of the driver on the basis of the information from the imaging unit.
   (19)

The information processing method according to any one of the above (11) to (18), wherein
in the estimation step, the seat position and the steering wheel position of the vehicle which positions are suitable for the driver to get on and off the vehicle are estimated on the basis of the three-dimensional information.
   (20)

The information processing method according to any one of the above (11) to (19), wherein
in the estimation step, a comfortable driving posture of the driver during automatic driving of the vehicle is estimated on the basis of the three-dimensional information.
   (21)

A vehicle control system comprising:
an imaging unit mounted on a vehicle; and
a control unit that controls the vehicle, wherein the control unit includes
a calculation unit that calculates three-dimensional information of a driver on a basis of information from the imaging unit, and
an estimation unit that estimates an optimal driving posture of the driver on a basis of the three-dimensional information.
   (22)

The vehicle control system according to the above (21), further comprising
a proposing unit that proposes the estimated optimal driving posture to the driver.
   (23)

The vehicle control system according to the above (21) or (22), further comprising
an automatic adjustment unit that automatically adjusts a seat position, a steering wheel position, and a mirror position of the vehicle on the basis of the estimated optimal driving posture.
   (24)

The vehicle control system according to any one of the above (21) to (23), wherein
the estimation unit estimates the optimal driving posture of the driver on the basis of the three-dimensional information, and ideal posture information set in advance.
   (25)

The vehicle control system according to any one of the above (21) to (23), wherein
the estimation unit estimates the optimal driving posture of the driver on the basis of the three-dimensional information, and an ideal posture model generated by machine learning.
   (26)

The vehicle control system according to any one of the above (21) to (25), wherein
the imaging unit includes a light source that emits light toward the driver, and a light receiving unit that receives light reflected by the driver.
   (27)

The vehicle control system according to the above (26), wherein
the light source emits infrared light toward the driver.
   (28)

The vehicle control system according to any one of the above (21) to (27), wherein
the calculation unit calculates a skeleton of the driver and an eyeball position of the driver as the three-dimensional information of the driver on the basis of the information from the imaging unit.
   (29)

The vehicle control system according to any one of the above (21) to (28), wherein
the estimation unit estimates the seat position and the steering wheel position of the vehicle which positions are suitable for the driver to get on and off the vehicle on the basis of the three-dimensional information.
   (30)

The vehicle control system according to any one of the above (21) to (29), wherein
the estimation unit estimates a comfortable driving posture of the driver during automatic driving of the vehicle on the basis of the three-dimensional information.

### REFERENCE SIGNS LIST

1 VEHICLE
11 VEHICLE CONTROL SYSTEM
26 IN-VEHICLE SENSOR
28 STORAGE UNIT
28a VEHICLE INTERIOR THREE-DIMENSIONAL INFORMATION
28b IDEAL POSTURE INFORMATION
32 VEHICLE CONTROL UNIT (EXAMPLE OF INFORMATION PROCESSING DEVICE AND CONTROL UNIT)
55 IMAGING UNIT
55a LIGHT SOURCE
55b LIGHT RECEIVING UNIT
87 ACQUISITION UNIT
88 CALCULATION UNIT
89 ESTIMATION UNIT
90 PROPOSING UNIT
91 AUTOMATIC ADJUSTMENT UNIT
D DRIVER

1. An information processing device comprising:
a calculation unit that calculates three-dimensional information of a driver on a basis of information from an imaging unit mounted on a vehicle; and
an estimation unit that estimates an optimal driving posture of the driver on a basis of the three-dimensional information.

2. The information processing device according to claim 1, further comprising
a proposing unit that proposes the estimated optimal driving posture to the driver.

3. The information processing device according to claim 1, further comprising
an automatic adjustment unit that automatically adjusts a seat position, a steering wheel position, and a mirror position of the vehicle on a basis of the estimated optimal driving posture.

4. The information processing device according to claim 1, wherein
the estimation unit estimates the optimal driving posture of the driver on a basis of the three-dimensional information, and ideal posture information set in advance.

5. The information processing device according to claim 1, wherein
the estimation unit estimates the optimal driving posture of the driver on a basis of the three-dimensional information, and an ideal posture model generated by machine learning.

6. The information processing device according to claim 1, wherein
the imaging unit includes a light source that emits light toward the driver, and a light receiving unit that receives light reflected by the driver.

7. The information processing device according to claim 6, wherein
the light source emits infrared light toward the driver.

8. The information processing device according to claim 1, wherein
the calculation unit calculates a skeleton of the driver and an eyeball position of the driver as the three-dimensional information of the driver on a basis of the information from the imaging unit.

9. The information processing device according to claim 1, wherein
the estimation unit estimates, on a basis of the three-dimensional information, a seat position and a steering wheel position of the vehicle which positions are suitable for the driver to get on and off the vehicle.

10. The information processing device according to claim 1, wherein
the estimation unit estimates a comfortable driving posture of the driver during automatic driving of the vehicle on a basis of the three-dimensional information.

11. An information processing method executed by a computer, the method comprising:
a calculation step of calculating three-dimensional information of a driver on a basis of information from an imaging unit mounted on a vehicle; and
an estimation step of estimating an optimal driving posture of the driver on a basis of the three-dimensional information.

12. A vehicle control system comprising:
an imaging unit mounted on a vehicle; and
a control unit that controls the vehicle, wherein
the control unit includes
a calculation unit that calculates three-dimensional information of a driver on a basis of information from the imaging unit, and
an estimation unit that estimates an optimal driving posture of the driver on a basis of the three-dimensional information.
